(19) United States
(12) Patent Application Publication
(10) Pub. No.: US 2026/0329403 A1
(43) Pub. Date: Oct. 22, 2026

(54) DISPLAY APPARATUS

(71) Applicant: LG Display Co., Ltd., Seoul (KR)

(72) Inventors: HyunWoo JANG, Paju-si (KR); Sojung JUNG, Paju-si (KR); Minchul KIM, Paju-si (KR)

(21) Appl. No.: 19/577,137

(22) Filed: Mar. 24, 2026

(30) Foreign Application Priority Data
Apr. 22, 2025 (KR) 10-2025-0052150

(51) Int. Cl. G06F 3/041

(52) U.S. Cl. CPC G06F 3/04184; G06F 3/04166

(57) ABSTRACT

A display apparatus in which a touch detection part may generate a touch synchronization signal and a touch timing signal by using a touch control signal transmitted from a touch control part.

### CROSS REFERENCE TO RELATED APPLICATION

This application claims priority from and the benefit of Korean Patent Application No. 10-2025-0052150, filed on April 22, 2025, which is hereby incorporated by reference for all purposes as if fully set forth herein.

### BACKGROUND

### Field

Embodiments of the invention relate generally to a display apparatus in which a touch detection part may generate a touch synchronization signal and a touch timing signal by using a touch control signal transmitted from a touch control part.

### Discussion of the Background

Display apparatuses are mounted on or provided in electronic products such as televisions, monitors, notebook computers, smartphones, tablet computers, electronic pads, wearable devices, watch phones, portable information devices, navigation devices, or vehicle control display apparatuses, etc., to display images.

For user's convenience, the display apparatus may be provided with touch electrodes capable of sensing a touch.

A touch control part may transmit a touch synchronization signal corresponding to an original touch synchronization signal and a touch timing signal that controls the timing at which touch driving signals are output to the touch electrodes to a touch detection part, and the touch detection part may detect a touch by using the touch synchronization signal and the touch timing signal.

In this case, at least two transmission lines may be provided between the touch control part and the touch detection part in order to transmit the touch synchronization signal and the touch timing signal.

Therefore, when the number of touch detection parts increases to improve touch sensitivity, the number of transmission lines required in the display apparatus increases, and accordingly, it may be difficult to provide all transmission lines within the display apparatus.

The above information disclosed in this Background section is only for understanding of the background of the inventive concepts, and, therefore, it may contain information that does not constitute prior art.

### SUMMARY

Display apparatuses according to embodiments of the invention are capable of providing a touch detection part which may generate a touch synchronization signal and a touch timing signal by using a touch control signal transmitted from a touch control part.

Additional features of the inventive concepts will be set forth in the description which follows, and in part will be apparent from the description, or may be learned by practice of the inventive concepts.

According to one or more embodiments of the invention, a display apparatus includes a display panel; a touch detection part that supplies touch driving signals to touch electrodes provided in the display panel and detects touch on the display panel based on touch electrode signals received from the touch electrodes; and a touch control part for transmitting a touch control signal including a touch sensing period signal indicating a touch sensing period in which touch is sensed and an output timing signal related to an output timing of touch driving signals output during the touch sensing period to the touch detection part. The touch detection part generates signals to be used in the touch detection part by using the touch control signal.

The touch detection part may generate a touch synchronization signal for distinguishing the touch sensing period from a display period in which an image is displayed and a touch timing signal for controlling outputs of the touch driving signals by using the touch control signal.

The touch control part may generate the touch control signal by using an original touch synchronization signal transmitted from a control part and transmits the touch control signal to the touch detection part, and the original touch synchronization signal may be a signal that distinguishes the touch sensing period from a display period in which the image is displayed.

When the original touch synchronization signal transmitted from the control part is changed from a first level to a second level, the touch control part may generate a touch start signal indicating a timing at which the touch sensing period starts, the touch control part may generate the output timing signal when a preset period elapses after the touch start signal is generated, and the touch control part may generate a touch end signal indicating a timing at which the touch sensing period ends when a preset period elapses after the output timing signal is generated.

A timing at which the touch end signal is terminated may occur earlier than or the same as a timing at which the original touch synchronization signal is changed from the second level to the first level.

The touch sensing period signal may include a touch start signal indicating a timing of a start of the touch sensing period and a touch end signal indicating a timing of an end of the touch sensing period. The output timing signal may be generated between the touch start signal and the touch end signal.

A frequency and the number of touch start signal pulses constituting the touch start signal may be the same as a frequency and number of touch end signal pulses constituting the touch end signal.

A frequency of touch start signal pulses constituting the touch start signal may be different from a frequency of touch end signal pulses constituting the touch end signal.

The number of touch start signal pulses constituting the touch start signal may be different from the number of touch end signal pulses constituting the touch end signal.

A width of a touch start signal pulse constituting the touch start signal may be different from a width of a touch end signal pulse constituting the touch end signal.

The touch control part may transmit a high-level signal to the touch detection part while an original touch synchronization signal transmitted from a control part is maintained at a first level, which is the high level. The touch control part may transmit the touch control signal including the touch sensing period signal and the output timing signal to the touch detection part when the original touch synchronization signal is changed from the first level to the second level.

The touch detection part may generate a touch synchronization signal for distinguishing a touch sensing period and a display period and a touch timing signal for controlling the output of the touch driving signals by using the touch control signal. The touch synchronization signal may be changed from a third level to a fourth level when the touch start signal is terminated, and may be changed from the fourth level to the third level when the touch end signal is terminated. The touch detection part may generate the touch timing signal while the touch synchronization signal is maintained at the fourth level. The touch timing signal may include touch timing signal pulses corresponding to output timing signal pulses included in the output timing signal.

The touch detection part may output touch driving signal pulses corresponding to the touch timing signal pulses to the touch electrodes.

A frequency of a touch start signal pulse constituting the touch start signal may be greater than a frequency of an output timing signal pulse constituting the output timing signal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is an exemplary diagram illustrating a configuration of a display apparatus according to an embodiment of the invention.

FIG. 2 is an exemplary circuit diagram illustrating a structure of a pixel applied to a display apparatus according to an embodiment of the invention.

FIG. 3 is an exemplary diagram illustrating a structure of a control part applied to a display apparatus according to an embodiment of the invention.

FIG. 4 is an exemplary diagram illustrating signals transmitted between a control part, a touch control part, a power supply part, and a touch detection part, which are applied to a display apparatus according to an embodiment of the invention.

FIG. 5 is a waveform diagram illustrating signals applied to a display apparatus according to an embodiment of the invention.

FIG. 6 is an exemplary diagram illustrating a structure of a touch control part applied to a display apparatus according to an embodiment of the invention.

FIG. 7 is an exemplary diagram illustrating a structure of a touch detection part applied to a display apparatus according to an embodiment of the invention.

FIG. 8, FIG. 9, FIGS. 10, and 11 are various waveform diagrams illustrating signals applied to a display apparatus according to an embodiment of the invention.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z – axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” may encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As is customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

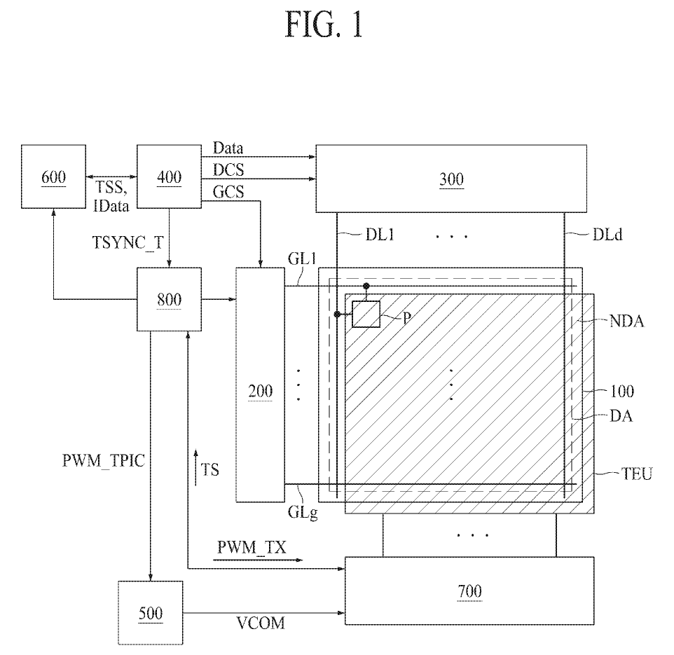

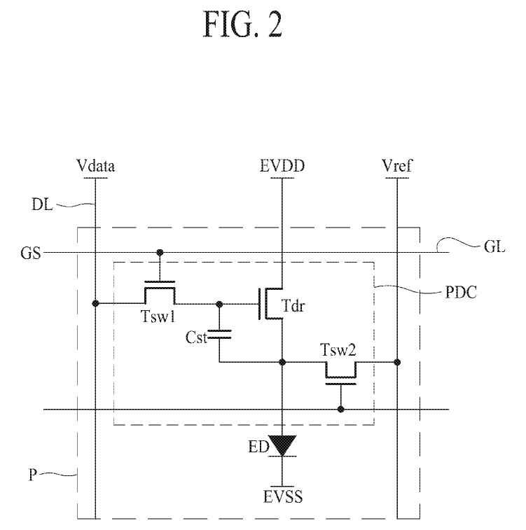

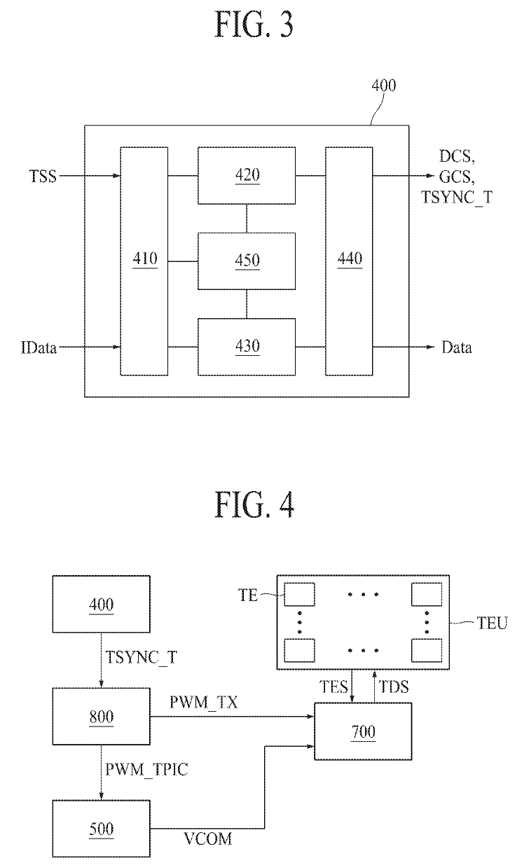

FIG. 1 is an exemplary diagram illustrating a configuration of a display apparatus according to an embodiment of the invention. FIG. 2 is an exemplary circuit diagram illustrating a structure of a pixel applied to a display apparatus according to an embodiment of the invention. FIG. 3 is an exemplary diagram illustrating a structure of a control part applied to a display apparatus according to an embodiment of the invention.

A display apparatus according to an embodiment of the invention may be used as various kinds of electronic devices. Electronic devices may be, for example, televisions, monitors, etc.

A display apparatus according to an embodiment of the invention, as illustrated in FIGS. 1 and 2, may include a display panel 100 which includes a display area DA displaying an image and a non-display area NDA provided outside the display area DA, a gate driver 200 which supplies gate signals GS to a plurality of gate lines GL1 to GLg provided in the display area DA of the display panel 100, a data driver 300 which supplies data voltages Vdata to a plurality of data lines DL1 to DLd provided in the display area DA of the display panel 100, a control part 400 which controls driving of the gate driver 200 and the data driver 300, a power supply part 500 which supplies power to the control part 400, the gate driver 200, the data driver 300, and the display panel 100, a touch electrode part TEU including touch electrodes, a touch detection part 700 that supplies touch driving signals to the touch electrode part TEU and detects a touch on the display panel 100 by using touch electrode signals received from the touch electrode part TEU, and a touch control part 800 that controls the operation of the touch detection part 700.

First, the display panel 100 may include a display area DA and a non-display area NDA. Gate lines GL1 to GLg, data lines DL1 to DLd, and pixels P may be provided in the display area DA. Accordingly, an image may be displayed in the display area DA. Here, g and d are natural numbers. The non-display area NDA may surround the outer periphery of the display area DA.

The pixel P included in the display panel 100, as illustrated in FIG. 2, may include a pixel driving circuit PDC which includes a switching transistor Tsw1, a storage capacitor Cst, a driving transistor Tdr, and a sensing transistor Tsw2, and a light emitting device ED electrically connected to the pixel driving circuit PDC. For example, the display panel may be a light emitting display panel.

However, the display panel 100 may be a liquid crystal display panel including a liquid crystal.

For example, the display panel applied to the display apparatus according to an embodiment of the invention may be any one of various types of display panels currently in use.

Next, the touch electrode part TEU may include touch electrodes.

The touch electrodes may be cathode electrodes included in a light emitting display panel or common electrodes included in a liquid crystal display panel. However, the touch electrodes may be separate electrodes independent of the cathode electrodes and the common electrodes.

Hereinafter, for convenience of description, a display apparatus in which cathode electrodes or common electrodes are used as touch electrodes is described as an example of a display apparatus according to an embodiment of the invention.

In this case, a driving period of the display apparatus may be divided into a display period for displaying an image and a touch sensing period for sensing a touch.

The touch electrode part TEU may be formed in a self-capacitance method or a mutual-capacitance method.

A touch driving signal generated by the touch detection part 700 may be transmitted to each of the touch electrodes provided in the touch electrode part TEU using the self-capacitance method. The touch electrode signals generated from the touch electrodes are transmitted to the touch detection part.

A touch driving signal generated by the touch detection part 700 may be sequentially transmitted to driving electrodes provided in the touch electrode part TEU using a mutual-capacitance method. For example, the touch electrode part TEU using the mutual-capacitance method may include driving electrodes to which a touch driving signal is supplied and receiving electrodes crossing the driving electrodes. Touch electrode signals generated from the receiving electrodes are transmitted to the touch detection part 700.

Next, the touch detection part 700 may supply touch driving signals to the touch electrode part TEU during the touch sensing period and detect a touch on the display panel 100 by using the touch electrode signals received from the touch electrode part TEU.

The touch detection part 700 may supply a cathode voltage or a common voltage to the touch electrode part TEU during the display period. Accordingly, an image may be displayed on the display panel during the display period. Hereinafter, for convenience of description, a signal supplied to the touch electrode part TEU during the display period will be referred to as a “common voltage”. For example, the display panel may display an image by using the common voltage supplied to the touch electrode part TEU during the display period.

Next, the touch control part 800 may control the operation of the touch detection part 700. To this end, the touch control part 800 may transmit a touch control signal PWM_TX including a touch sensing period signal indicating a touch sensing period at which a touch is sensed and an output timing signal related to an output timing of touch driving signals outputted during the touch sensing period to the touch detection part 700.

The touch control part 800 may generate the touch control signal PWM_TX by using an original touch synchronization signal TSYNC_T transmitted from the control part 400.

The touch control part 800 may generate touch coordinates of an area in which a touch is detected by using touch signals TS transmitted from the touch detection part 700, and may transmit the generated touch coordinates to an external system 600. For example, the touch signal TS is a signal transmitted from the touch detection part 700, and the touch signal TS may include various pieces of information related to determining touch coordinates.

Next, the control part 400 may realign input data signal IData transmitted from the external system 600 by using a timing synchronization signal TSS transmitted from the external system 600 and may generate a data control signal DCS which is to be supplied to the data driver 300 and a gate control signal GCS which is to be supplied to the gate driver 200.

To this end, as illustrated in FIG. 3, the control part 400 may include a data aligner 430 which realigns input data signal IData to generate data signal Data, a control signal generator 420 which generates the gate control signal GCS and the data control signal DCS by using the timing synchronization signal TSS, an input part 410 which transmits the timing synchronization signal TSS transmitted from the external system 600 to the control signal generator 420 and transmits the input data signal IData transmitted from the external system 600 to the data aligner 430, and an output part 440 which supplies the data driver 300 with the data signal Data generated by the data aligner 430 and the data control signal DCS generated by the control signal generator 420 and supplies the gate driver 200 with the gate control signal GCS generated by the control signal generator 420.

The control part 400 may further include a storage part 450 for storing various information. The storage part 450 may be included in the control part 400 as illustrated in FIG. 3 but may be separated from the control part 400 and provided independently.

The control part 400 may generate an original touch synchronization signal TSYNC_T for distinguishing the touch sensing period and the display period and transmit the original touch synchronization signal to the touch control part 800. The touch control part 800 may generate a touch control signal PWM_TX by using the original touch synchronization signal and transmit the touch control signal PWM_TX to the touch detection part 700.

The external system 600 may perform a function of driving the control part 400 and an electronic device.

For example, when the electronic device is a television (TV), the external system 600 may receive various kinds of sound information and image information over a communication network and may transmit the received image information to the control part 400. For example, the external system 600 may convert the image information into input data signal IData and transmit the input data signal IData to the control part 400.

The external system 600 may control various functions of the electronic device by using touch coordinates transmitted from the touch control part 800.

The power supply part 500 may generate various powers and supply the generated powers to the control part 400, the gate driver 200, the data driver 300, the display panel 100, the touch detection part 700, and the touch control part 800. For example, although FIG. 1 shows that the power supply part 500 is electrically connected only to the touch detection part 700, the power supply part 500 may supply power to various components included in the display apparatus.

In addition, the power supply part 500 may generate a common voltage based on a power control signal PWM_TPIC transmitted from the touch control part 800 during the display period and transmit the common voltage to the touch detection part 700. Also, the power supply part 500 may generate and transmit a touch driving power VCOM used for generating the touch driving signal based on the power control signal PWM_TPIC during the touch sensing period to the touch detection part 700.

For example, the common voltage may be supplied to the touch electrodes during the display period, and the touch driving signal may be supplied to the touch electrodes during the touch sensing period.

Next, the gate driver 200 may be directly embedded into the non-display area NDA by using a gate-in panel (GIP) type, or the gate driver 200 may be provided in the display area DA in which light emitting devices ED are provided, or the gate driver 200 may be provided on a chip on film mounted in the non-display area NDA.

The gate driver 200 may supply gate pulses to the gate lines GL1 to GLg.

For example, when a gate pulse generated by the gate driver 200 is supplied to a gate of the switching transistor Tsw1 included in the pixel P illustrated in FIG. 2, the switching transistor Tsw1 may be turned on. When the switching transistor Tsw1 is turned on, data voltage Vdata supplied through a data line DL may be supplied to the pixel P.

When a gate-off signal generated by the gate driver 200 is supplied to the switching transistor Tsw1, the switching transistor Tsw1 may be turned off. When the switching transistor Tsw1 is turned off, a data voltage may not be supplied to the pixel P any longer.

The gate signal GS supplied to the gate line GL may include the gate pulse and the gate-off signal.

To supply gate pulses to gate lines GL1 to GLg, the gate driver 200 may include stages electrically connected to gate lines GL1 to GLg.

Each of the stages may be electrically connected to one gate line GL, but may be electrically connected to at least two gate lines GL.

In order to generate gate pulses, a gate start signal and at least one gate clock which are generated by the control signal generator 420 may be transferred to the gate driver 200. For example, the gate start signal and the at least one gate clock may be included in the gate control signal GCS.

One of the stages may be driven by a gate start signal to output a gate pulse to a gate line GL. The gate pulse may be generated by a gate clock.

At least one of signals output from a stage where a gate pulse is output may be supplied to another stage to drive another stage. Accordingly, a gate pulse may be output in another stage.

For example, the stages may be driven sequentially to sequentially supply the gate pulses to the gate lines GL.

Finally, the data driver 300 may supply data voltages Vdata to the data lines DL1 to DLd.

To this end, the data driver 300 may include a shift register which outputs a sampling signal, a latch which latches data signal Data received from the control part 400, a digital-to-analog converter which converts the data signal Data transmitted from the latch into a data voltage Vdata and outputs the data voltage Vdata, and an output buffer which outputs the data voltage transmitted from the digital-to-analog converter to the data line DL on the basis of a source output enable signal SOE.

The data voltages Vdata supplied to the data lines DL1 to DLd may be supplied to pixels P electrically connected to a gate line GL supplied with a gate pulse.

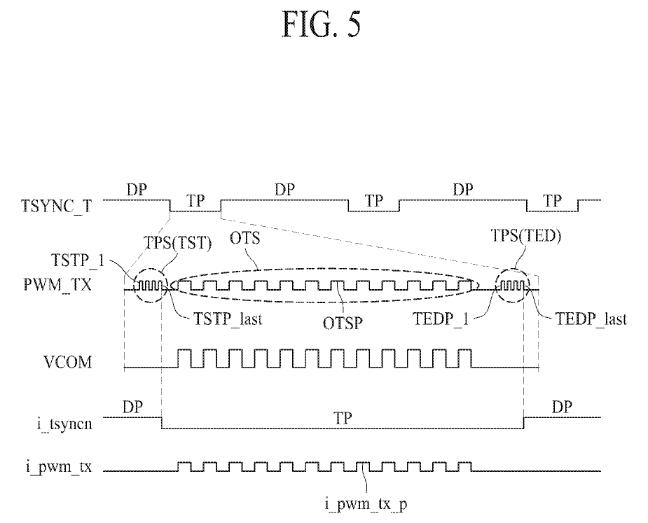

FIG. 4 is an exemplary diagram illustrating signals transmitted between a control part, a touch control part, a power supply part, and a touch detection part, which are applied to a display apparatus according to an embodiment of the invention. Hereinafter, for convenience of description, a display apparatus according to an embodiment of the invention will be described using a touch electrode part TEU using a self-capacitance method. Accordingly, the touch driving signal TDS generated by the touch detection part 700 may be transmitted to each of the touch electrodes TE provided in the touch electrode part TEU using the self-capacitance method.

As described above, a display apparatus according to an embodiment of the invention includes the control part 400, the touch control part 800, the touch detection part 700, and the power supply part 500.

The touch control part 800 may transmit a touch control signal PWM_TX to the touch detection part 700. The touch control signal PWM_TX may include a touch sensing period signal indicating a touch sensing period in which a touch is sensed and an output timing signal related to an output timing of the touch driving signals TDS output during the touch sensing period.

The touch detection part 700 supplies the touch driving signals TDS to the touch electrodes TE provided in the display panel 100 and analyzes touch sensing signals generated by touch electrode signals TES received from the touch electrodes TE to detect a touch on the display panel.

The touch detection part 700 may supply the touch driving signals TDS to the touch electrodes TE during the touch sensing period by using the touch control signal PWM_TX. For example, the touch detection part 700 may generate the touch driving signals TDS by using the touch control signal PWM_TX. Also, the touch detection part 700 may select timings for outputting the touch driving signals TDS to the touch electrodes by using the touch control signal PWM_TX.

The control part 400 may transmit an original touch synchronization signal TSYNC_T, which divides the display period and the touch sensing period, to the touch control part 800. The touch control part 800 may generate the touch control signal PWM_TX by using the original touch synchronization signal TSYNC_T.

The power supply part 500 may generate a touch driving power VCOM used to generate the touch driving signal TDS on the basis of the power control signal PWM_TPIC transmitted from the touch control part 800 and transmit the touch driving power VCOM to the touch detection part 700.

The power control signal PWM_TPIC may be the same signal as the touch control signal PWM_TX but may also be different from the touch control signal PWM_TX. When the power control signal PWM_TPIC is different from the touch control signal PWM_TX, the power control signal PWM_TPIC may include an output timing signal included in the touch control signal PWM_TX.

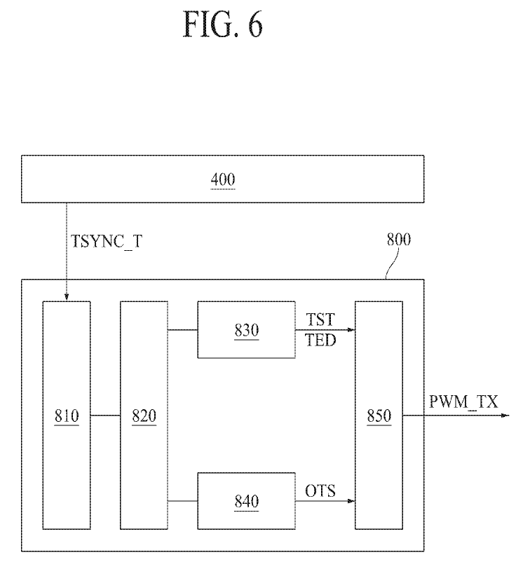

Hereinafter, a method by which the touch control part 800 generates a touch control signal PWM_TX and a method by which the touch detection part 700 generates a touch synchronization signal and a touch timing signal by using the touch control signal PWM_TX will be described with reference to FIGS. 5 - 7.

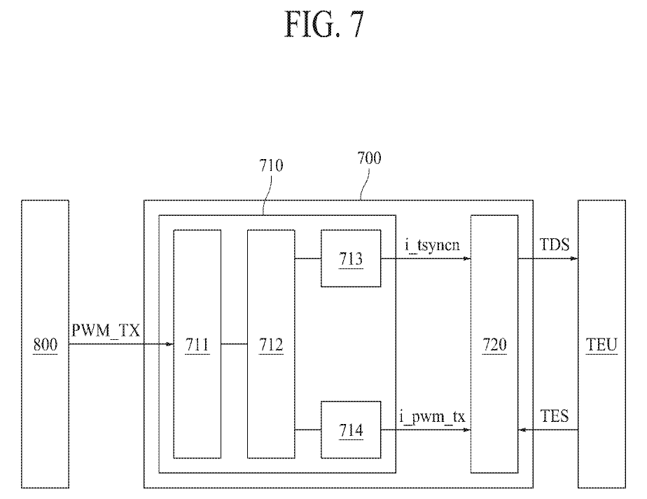

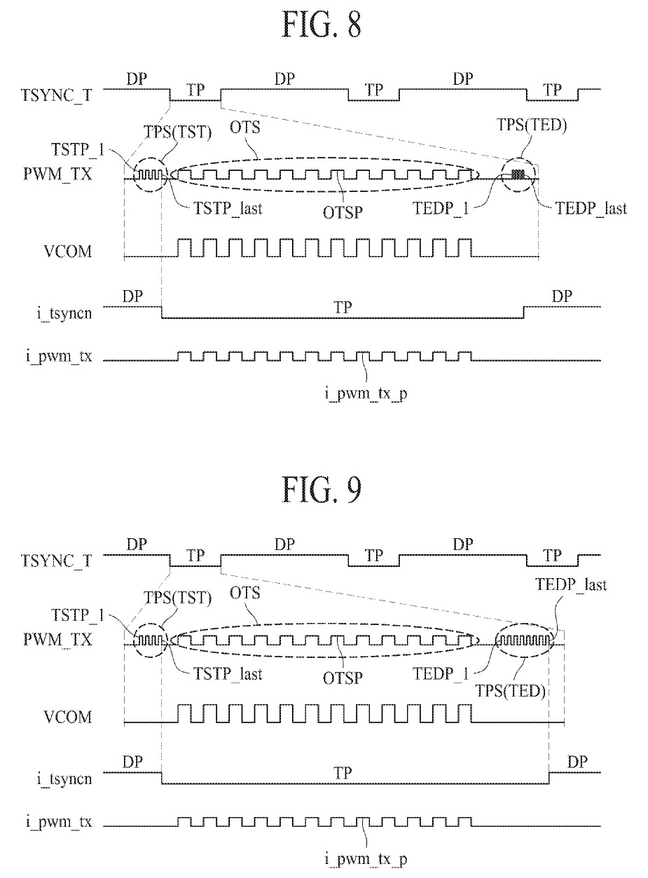

FIG. 5 is a waveform diagram illustrating signals applied to a display apparatus according to an embodiment of the invention, FIG. 6 is an exemplary diagram illustrating a structure of a touch control part applied to a display apparatus according to an embodiment of the invention, and FIG. 7 is an exemplary diagram illustrating a structure of a touch detection part applied to a display apparatus according to an embodiment of the invention.

First, a method of generating the touch control signal PWM_TX by the touch control part 800 will be described with reference to FIGS. 4 - 6.

As described above, the control part 400 may transmit the original touch synchronization signal TSYNC_T for distinguishing the display period DP and the touch sensing period TP to the touch control part 800.

In this case, the touch control part 800 may generate the touch control signal PWM_TX by using the original touch synchronization signal TSYNC_T.

As shown in FIG. 5, the touch control signal PWM_TX may include a touch sensing period signal TPS indicating that it is a touch sensing period TP for sensing a touch and an output timing signal OTS related to the output timing of the touch driving signals TDS output during the touch sensing period TP.

The touch sensing period signal TPS may include a touch start signal TST indicating a timing at which the touch sensing period TP starts and a touch end signal TED indicating a timing at which the touch sensing period TP ends.

In this case, the output timing signal OTS may be included between the touch start signal TST and the touch end signal TED.

For example, the touch control part 800 may generate a touch start signal TST, an output timing signal OTS, and a touch end signal TED by using the original touch synchronization signal TSYNC_T.

For example, when the original touch synchronization signal TSYNC_T transmitted from the control part 400 is changed from a first level to a second level, the touch control part 800 may generate a touch start signal TST indicating a timing of a start of the touch sensing period TP.

Here, the first level may be a high level in the example shown in FIG. 5, and the second level may be a low level. For example, the first level may be a voltage higher than the second level.

In addition, the touch start signal TST may be included in the touch sensing period signal TPS, and the touch start signal TST may include at least one touch start signal pulse TSTP.

For example, the touch control part 800 may generate a first touch start signal pulse TSTP_1 that changes from a low level to a high level at a time when the original touch synchronization signal TSYNC_T changes from a high level to a low level. The first touch start signal pulse TSTP_1 may be the first generated touch start signal pulse TSTP among at least one touch start signal pulse TSTP included in the touch start signal TST.

However, as shown in FIG. 5, the touch control part 800 may generate a first touch start signal pulse TSTP_1 that changes from a low level to a high level when a preset period elapses after the original touch synchronization signal TSYNC_T changes from a high level to a low level.

To provide an additional description, the timing at which the first touch start signal pulse TSTP_1 is generated may be the same as a timing at which the original touch synchronization signal TSYNC_T changes from a high level to a low level, or be a timing after the touch synchronization signal TSYNC_T changes from a high level to a low level and a preset period has elapsed, as shown in FIG. 5.

The touch control part 800 may generate an output timing signal OTS when a preset period elapses after the last generated touch start signal pulse (hereinafter, simply referred to as the last touch start signal pulse TSTP_last) among the touch start signal pulses TSTP is output. The output timing signal OTS may also include at least two output timing signal pulses OTSP.

For example, when the touch start signal TST includes four touch start signal pulses TSTP as shown in FIG. 5, the touch control part 800 may generate output timing signal pulses OTSP when a preset period elapses after generating four touch start signal pulses TSTP.

The frequency and number of output timing signal pulses OTSP may be the same as the frequency and number of touch driving signal pulses constituting the touch driving signal TDS. That is, the output timing signal pulses OTSP may correspond to touch driving pulses.

In this case, in order to allow the touch detection part 700 to distinguish between the touch start signal TST and the output timing signal OTS, the frequency of the touch start signal TST may be set higher than the frequency of the output timing signal OTS. In this case, the frequency of the touch end signal TED may be higher than the frequency of the output timing signal OTS. Also, the frequency of the touch end signal TED may be the same as or different from the frequency of the touch start signal TST.

The touch control part 800 may generate a touch end signal TED indicating the timing at which the touch sensing period TP ends when a preset period elapses after the output timing signal OTS is generated. For example, the touch control part 800 may generate a touch end signal TED when a preset period elapses after the last output timing signal pulse OTSP among the output timing signal pulses OTSP is output.

The touch end signal TED may be included in the touch sensing period signal TPS, and the touch end signal TED may include at least one touch end signal pulse TEDP.

For example, the touch control part 800 may generate a first touch end signal pulse TEDP_1 that changes from a low level to a high level when a preset period elapses after the output of the output timing signal OTS is terminated. The first touch end signal pulse TEDP_1 may be the first generated touch end signal pulse TEDP among the touch end signal pulses TEDP included in the touch end signal TED.

The touch control part 800 may match the timing at which the last generated touch end signal pulse (hereinafter, simply referred to as the last touch end signal pulse TEDP_last) among the touch end signal pulses included in the touch end signal TED changes from a high level to a low level and the timing at which the original touch synchronization signal TSYNC_T changes from a low level to a high level.

However, as shown in FIG. 5, the touch control part 800 may control the output timing of the touch end signal TED so that the original touch synchronization signal TSYNC_T changes from a low level to a high level after the last touch end signal TEDP_last changes from a high level to a low level.

To provide an additional description, the timing at which the touch termination signal TED is terminated may be the same as the timing at which the original touch synchronization signal TSYNC_T changes from a low level to a high level. However, as shown in FIG. 5, the timing at which the touch end signal TED is terminated may occur earlier than the timing at which the original touch synchronization signal TSYNC_T changes from a low level to a high level.

In the above-described example, the period after the original touch synchronization signal TSYNC_T changes from a high level to a low level until the first touch start signal pulse TSTP_1 is output, the period after the last touch start signal pulse TSTP_last is generated until the output timing signal pulse OTSP is output, the period after the output timing signal pulse OTSP is output until the first touch end signal pulse TEDP_1 is output, and the period between the timing at which the generation of the touch end signal TED is terminated and the timing at which the original touch synchronization signal TSYNC_T changes from a low level to a high level may be variously set during the manufacturing process of the display apparatus. Also, the set periods may be stored in the touch control part 800.

As shown in FIG. 6, in order to perform the function as described above, the touch control part 800 may include a receiving part 810 for receiving the original touch synchronization signal TSYNC_T transmitted from the control part 400, a determination part 820 for determining a level change of the original touch synchronization signal TSYNC_T, a first generation part 830 for generating a touch start signal TST and a touch end signal TED under the control of the determination part 820, a second generation part 840 for generating an output timing signal OTS under the control of the determination part 820, and a touch control signal output part 850 for outputting the touch start signal TST, the output timing signal OTS, and the touch end signal TED to the touch detection part 700.

For example, as shown in FIG. 5, when the original touch synchronization signal TSYNC_T changes from a high level to a low level, the determination part 820 may generate the touch start signal TST by driving the first generation part 830, generate the output timing signal OTS by driving the second generation part 840 when the generation of the touch start signal TST is terminated, and generate the touch end signal TED by driving the first generation part 830 again when the generation of the output timing signal OTS is terminated.

In this case, the touch control signal output part 850 may sequentially output the touch start signal TST, the output timing signal OTS, and the touch end signal TED transmitted from the first generation part 830 and the second generation part 840 to the touch detection part 700.

Second, referring to FIGS. 4 - 7, a method in which the touch detection part 700 generates a touch synchronization signal i_tsyncn and a touch timing signal i_pwm_tx by using the touch control signal PWM_TX is described.

As described above, the touch control part 800 may generate the touch control signal PWM_TX by using the original touch synchronization signal TSYNC_T. The touch control signal PWM_TX may include a touch sensing period signal TPS indicating that it is the touch sensing period TP for sensing a touch and an output timing signal OTS related to the output timing of the touch driving signals TDS output during the touch sensing period TP.

The touch detection part 700 may generate a touch synchronization signal i_tsyncn for distinguishing the touch sensing period TP and the display period DP and a touch timing signal i_pwm_tx for controlling the output of the touch driving signals TDS by using the touch control signal PWM_TX.

For example, the touch synchronization signal i_tsync may change from a third level to a fourth level when the touch start signal TST is terminated, and may change from the fourth level to the third level when the touch end signal TED is terminated.

In addition, the touch detection part 700 may generate the touch timing signal i_pwm_tx while the touch synchronization signal i_tsyncn is maintained at the fourth level. In this case, the touch timing signal i_pwm_tx may include touch timing signal pulses i_pwm_tx_p corresponding to output timing signal pulses OTSP included in the output timing signal OTS. In this case, the frequency and number of the output timing signal pulses OTSP may be the same as those of the timing signal pulses i_pwm_tx_p.

For example, before the last touch start signal pulse TSTP_last included in the touch control signal PWM_TX is received, the touch detection part 700 may generate a touch synchronization signal i_tsyncn having a third level. The phase of the third level of the touch synchronization signal i_tsyncn may be the same as the phase of the first level of the original touch synchronization signal TSYNC_T. For example, the third level and the first level may be high levels.

However, the phase of the third level and the phase of the first level need not necessarily be the same, and the size of the third level and the size of the first level need not necessarily be the same.

The period during which the touch synchronization signal i_tsyncn has the third level may be the display period DP.

After the last touch start signal pulse TSTP_last included in the touch control signal PWM_TX is received, the touch detection part 700 may generate a touch synchronization signal i_tsyncn having a fourth level.

In this case, when a preset period elapses after the last touch start signal pulse TSTP_last is received, the touch detection part 700 may generate a touch synchronization signal i_tsyncn having a fourth level.

However, the touch detection part 700, as shown in FIG. 5, may generate a touch synchronization signal i_tsyncn having a fourth level when the last touch start signal pulse TSTP_last changes from a high level to a low level.

A period during which the touch synchronization signal i_tsyncn has the fourth level may be the touch sensing period TP.

The touch detection part 700 may generate the touch timing signal i_pwm_tx while the touch synchronization signal i_tsyncn is maintained at the fourth level. For example, if a preset period elapses after the touch synchronization signal i_tsyncn is changed to the fourth level, the touch detection part 700 may generate the touch timing signal i_pwm_tx.

In this case, the touch timing signal i_pwm_tx may include touch timing signal pulses i_pwm_tx_p corresponding to output timing signal pulses OTSP included in the output timing signal OTS.

The touch timing signal pulses i_pwm_tx_p may be continuously generated while the touch synchronization signal i_tsyncn is maintained at the fourth level.

For example, the touch timing signal pulses i_pwm_tx_p may be generated only during the touch sensing period TP during which the touch synchronization signal i_tsyncn is maintained at the fourth level.

During a period when the touch timing signal pulses i_pwm_tx_p are not generated, the touch timing signal i_pwm_tx may be maintained at a low level, for example, as shown in FIG. 5. For example, the touch timing signal i_pwm_tx may include a signal maintained at a low level and touch timing signal pulses i_pwm_tx_p.

When a preset period elapses after the touch timing signal pulses i_pwm_tx_p are generated, the touch end signal pulses TEDP are generated.

After the last touch end signal pulse TEDP_last is received, the touch detection part 700 may generate a touch synchronization signal i_tsyncn having a third level.

In this case, when a preset period elapses after the last touch end signal pulse TEDP_last is received, the touch detection part 700 may generate a touch synchronization signal i_tsyncn having a third level.

However, the touch detection part 700 may change the level of the touch synchronization signal i_tsyncn from the fourth level to the third level when the last touch end signal pulse TEDP_last is changed from the high level to the low level, as shown in FIG. 5.

As described above, a period in which the touch synchronization signal i_tsyncn has the third level may mean the display period DP.

In the above-described example, the period after the last touch start signal pulse TSTP_last is output until the touch synchronization signal i_tsyncn of the fourth level is generated, the period after the touch synchronization signal i_tsyncn of the fourth level is generated until the touch timing signal pulse i_pwm_tx_p is output, the period after the touch timing signal pulses i_pwm_tx_p is generated until the touch end signal pulses TEDP are generated, and the period after the last touch end signal pulse TEDP_last is generated until the touch synchronization signal i_tsyncn is changed to the third level may be variously set in the manufacturing process of the display apparatus. Also, the set periods may be stored in the touch control part 800.

The touch detection part 700 may generate signals to be used by the touch detection part 700 during the touch sensing period TP by using the touch control signal PWM_TX.

For example, the touch synchronization signal i_tsyncn and the touch timing signal i_pwm_tx generated by the touch detection part 700 by using the touch control signal PWM_TX may be used for generating and outputting the touch driving signal TDS.

For example, the touch synchronization signal i_tsyncn is a signal corresponding to the original touch synchronization signal TSYNC_T, and accordingly, the touch detection part 700 may distinguish the touch sensing period TP and the display period DP by the touch synchronization signal i_tsyncn.

However, the touch sensing period TP of the original touch synchronization signal TSYNC_T is not completely the same as the touch sensing period TP of the touch synchronization signal i_tsyncn, and the display period DP of the original touch synchronization signal TSYNC_T is not completely the same as the display period DP of the touch synchronization signal i_tsyncn.

For example, as described with reference to FIG. 5, after the touch sensing period TP start and the touch start signal TST is generated by the original touch synchronization signal TSYNC_T, the touch sensing period TP of the touch synchronization signal i_tsyncn starts. Therefore, the timing at which the touch sensing period TP of the original touch synchronization signal TSYNC_T starts is different from the timing at which the touch sensing period TP of the touch synchronization signal i_tsyncn starts.

Also, as described with reference to FIG. 5, the timing at which the touch end signal TED ends and the timing at which the touch sensing period TP of the original touch synchronization signal TSYNC_T ends may be the same or different. Also, the timing at which the touch end signal TED ends and the timing at which the touch sensing period TP of the touch synchronization signal i_tsyncn ends may be the same or different. Therefore, the timing at which the touch sensing period TP of the original touch synchronization signal TSYNC_T ends may be different from the timing at which the touch sensing period TP of the touch synchronization signal i_tsyncn ends.

Accordingly, the touch sensing period TP of the original touch synchronization signal TSYNC_T is different from the touch sensing period TP of the touch synchronization signal i_tsyncn. However, the touch sensing period TP of the touch synchronization signal i_tsyncn may be included in the touch sensing period TP of the original touch synchronization signal TSYNC.

Therefore, in the invention, the same reference numerals are assigned to the touch sensing period TP of the original touch synchronization signal TSYNC_T and the touch sensing period TP of the touch synchronization signal i_tsyncn.

The touch detection part 700 may output touch driving signal pulses corresponding to the touch timing signal pulses i_pwm_tx_p to the touch electrodes. In this case, the touch driving signal TDS may include at least one touch driving signal pulse.

For example, when the touch electrode part TEU is configured in a self-capacitance method, at least one touch driving signal pulse corresponding to at least one touch timing signal pulse i_pwm_tx_p may be supplied to each of the touch electrodes TE provided in the touch electrode part TEU.

To provide an additional description, the touch detection part 700 may generate at least one touch driving signal pulse corresponding to the at least one touch timing signal pulse i_pwm_tx_p and supply the at least one touch driving signal pulse to the touch electrode TE. In this case, the at least one touch driving signal pulse may be a touch driving signal.

For example, the touch detection part 700 may generate touch driving signal pulses by using the touch timing signal i_pwm_tx generated from the touch control signal PWM_TX and the touch driving power VCOM transmitted from the power supply part 500. In this case, the touch timing signal i_pwm_tx may be a digital signal, and the touch driving power VCOM may be an analog signal.

For example, the touch detection part 700 may control the operation of the touch detection part 700 by using the touch timing signal i_pwm_tx, which is a digital signal, and may generate the touch driving signal TDS to be supplied to the touch electrode TE by using the touch driving power VCOM, which is an analog signal.

The power supply part 500 may generate the touch driving power VCOM by using the power control signal PWM_TPIC transmitted from the touch control part 800.

As described above, the power control signal PWM_TPIC may be the same signal as the touch control signal PWM_TX, but may also be different from the touch control signal PWM_TX. When the power control signal PWM_TPIC is different from the touch control signal PWM_TX, the power control signal PWM_TPIC may include an output timing signal OTS included in the touch control signal PWM_TX.

In order to perform the above-described functions, the touch detection part 700 may include a signal generation part 710 for generating a touch synchronization signal i_tsyncn and a touch timing signal i_pwm_tx by using a touch control signal PWM_TX transmitted from the touch control part 800, and a detection part 720 for generating a touch driving signal TDS to be transmitted to the touch electrode part TEU by using the touch synchronization signal i_tsyncn and touch timing signal i_pwm_tx, which are generated in the signal generation part 710 and detecting a touch in the touch electrode part TEU by using the touch electrode signal TES transmitted from the touch electrode part TEU by the touch driving signal TDS.

The signal generation part 710 may include a touch control signal receiving part 711, a level determination part 712, a touch synchronization signal generation part 713, and a touch timing signal generation part 714. The touch control signal receiving part 711 receives the touch control signal PWM_TX transmitted from the touch control part 800, the level determination part 712 determines a change in the level of the touch control signal PWM_TX, the touch synchronization signal generation part 713 generates the touch synchronization signal i_tsyncn under the control of the level determination part 712, and the touch timing signal generation part 714 generates the touch timing signal i_pwm_tx under the control of the level determination part 712.

For example, as shown in FIG. 5, when the touch start signal TST of the touch control signal PWM_TX is received, the level determination part 712 generates a touch synchronization signal i_tsyncn having a fourth level by driving the touch synchronization signal generation part 713. Also, when a touch synchronization signal i_tsyncn having a fourth level is generated, the level determination part 712 drives the touch timing signal generation part 714 to generate a touch timing signal i_pwm_tx including touch timing signal pulses i_pwm_tx_p. Also, when the generation of the touch timing signal pulses i_pwm_tx_p is completed, the level determination part 712 drives the touch synchronization signal generation part 713 to generate a touch synchronization signal i_tsyncn having a third level.

The detection part 720 may check the start of the touch sensing period TP by using the touch synchronization signal i_tsyncn.

When the touch sensing period TP starts, the detection part 720 may generate a touch driving signal TDS to be supplied to the touch electrode TE by using the touch timing signal pulses i_pwm_tx_p and the touch driving power VCOM.

The detection part 720 may transmit at least one touch driving signal pulse generated by using the at least one touch timing signal pulse i_pwm_tx_p to the touch electrode TE, and may detect a touch at the touch electrode TE by using the touch electrode signal TES transmitted from the touch electrode TE by the at least one touch driving signal pulse.

In this case, when the touch electrodes TE are divided into at least two active groups, the detection part 720 may sequentially supply touch driving signals to the active groups.

For example, the detection part 720 may supply at least one touch driving signal pulse to each of the touch electrodes included in a first active group, and then supply at least one touch driving signal pulse to each of the touch electrodes included in a second active group.

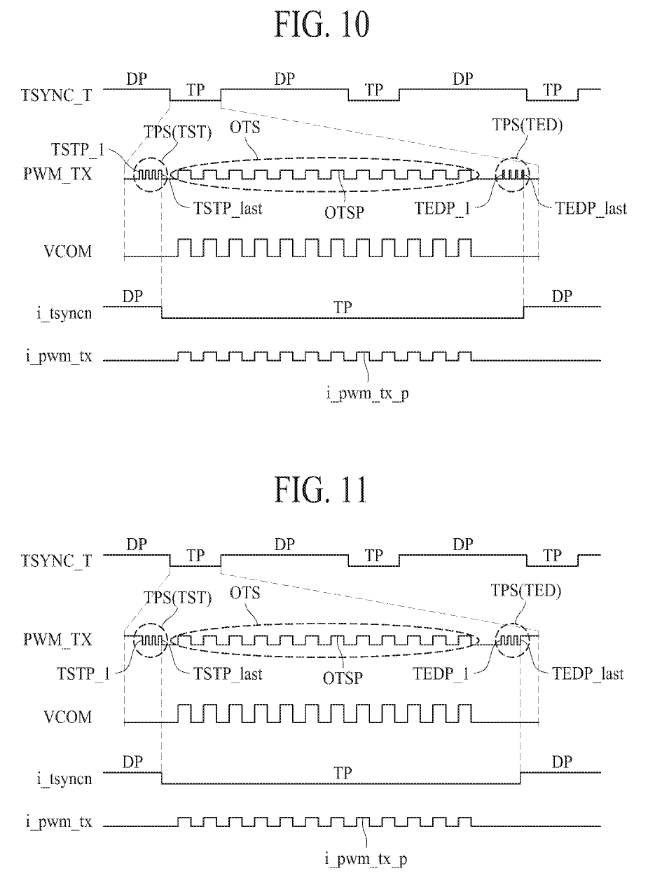

FIGS. 8 - 11 are various waveform diagrams illustrating signals applied to a display apparatus according to an embodiment of the invention. In the following descriptions, details that are the same as or similar to those described with reference to FIGS. 1 - 7 are omitted or briefly described. Furthermore, in the following description, the frequency of the signal may have the same meaning as the frequency of the pulse constituting the signal.

First of all, in the display apparatus according to an embodiment of the invention, as shown in FIG. 5, the frequency and number of the touch start signal pulse TSTP constituting the touch end signal TED may be the same as the frequency and number of the touch end signal pulse TEDP constituting the touch end signal TED.

In this case, the frequency of the touch start signal TST may be greater than the frequency of the output timing signal pulse OTSP constituting the output timing signal OTS, and thus, the frequency of the touch end signal pulse TEDP may also be greater than the frequency of the output timing signal pulse OTSP.

Therefore, when a touch start signal TST having a frequency greater than a frequency of the output timing signal OTS is received, the touch detection part 700 may change the touch synchronization signal i_tsyncn to the fourth level. Accordingly, the touch detection part 700 may perform an operation in the touch sensing period TP.

When the generation of the output timing signal OTS is terminated and the touch end signal TED having a frequency greater than the frequency of the output timing signal OTS is received, the touch detection part 700 may change the touch synchronization signal i_tsyncn to the third level, and accordingly, the touch detection part 700 may perform the operation in the display period DP.

During the display period DP, the touch detection part 700 may supply a common voltage to all the touch electrodes TE provided in the touch electrode part TEU. An image may be displayed on the display panel 100 by the common voltage supplied to the touch electrodes TE.

Next, in the display apparatus according to an embodiment of the invention, as shown in FIG. 8, the frequency of the touch start signal pulse TSTP constituting the touch end signal TED may be different from the frequency of the touch end signal pulse TEDP constituting the touch end signal TED. For example, the frequency of the touch start signal pulse TSTP may be less than the frequency of the touch end signal pulse TEDP.

In this case, the frequency of the touch start signal TST may be greater than the frequency of the output timing signal OTS. Accordingly, the frequency of the touch start signal pulse TSTP and the frequency of the touch end signal pulse TEDP may be greater than the frequency of the output timing signal pulse OTSP.

Accordingly, when a touch start signal TST having a frequency greater than the frequency of the output timing signal OTS and a frequency different from the frequency of the touch end signal TED is received, the touch detection part 700 may change the touch synchronization signal i_tsyncn to the fourth level. Accordingly, the touch detection part 700 may perform an operation in the touch sensing period TP.

When the generation of the output timing signal OTS is terminated and the touch end signal TED having a frequency greater than the frequency of the output timing signal OTS and a frequency different from the frequency of the touch start signal TST is received, the touch detection part 700 may change the touch synchronization signal i_tsyncn to the third level, and accordingly, the touch detection part 700 may perform the operation in the display period DP.

Next, in the display apparatus according to an embodiment of the invention, as shown in FIG. 9, the number of touch start signal pulses TSTP constituting the touch end signal TED may be different from the number of touch end signal pulses TEDP constituting the touch end signal TED. For example, the number of touch start signal pulses TSTP may be less than the number of touch end signal pulses TEDP.

In this case, the frequency of the touch start signal pulse TSTP and the frequency of the touch end signal pulse TEDP may be the same. Also, the frequency of the touch start signal TST may be greater than the frequency of the output timing signal OTS. For example, the frequency of the touch start signal pulse TSTP and the frequency of the touch end signal pulse TEDP may be greater than the frequency of the output timing signal OTS.

Accordingly, when a touch start signal TST, which has a frequency greater than the frequency of the output timing signal OTS and a smaller number of touch start signal pulses TSTP than the number of touch end signal pulses TEDP, is received, the touch detection part 700 may change the touch synchronization signal i_tsyncn to the fourth level. Accordingly, the touch detection part 700 may perform the operation in the touch sensing period TP.

When the generation of the output timing signal OTS is terminated and the touch end signal TED, which has a frequency greater than the frequency of the output timing signal OTS and a frequency different from the frequency of the touch start signal pulse TSTP, is received, the touch detection part 700 may change the touch synchronization signal i_tsyncn to the third level, and accordingly, the touch detection part 700 may perform the operation in the display period DP.

Next, in the display apparatus according to an embodiment of the invention, as shown in FIG. 10, the width of the touch start signal pulse TSTP constituting the touch start signal TST may be different from the width of the touch end signal pulse TEDP constituting the touch end signal TED. For example, the width of the touch start signal pulse TSTP may be greater than the width of the touch end signal pulse TEDP. In addition, the duty ratio of the touch start signal pulse TSTP may be greater than the duty ratio of the touch end signal pulse TEDP.

In this case, the frequency of the touch start signal TST may be greater than the frequency of the output timing signal OTS. For example, the frequency of the touch start signal pulse TSTP and the frequency of the touch end signal pulse TEDP may be greater than the frequency of the output timing signal pulse OTSP.

Accordingly, when a touch start signal TST having a frequency greater than the frequency of the output timing signal OTS and having a duty ratio different from the duty ratio of the touch end signal pulse TEDP is received, the touch detection part 700 may change the touch synchronization signal i_tsyncn to the fourth level. Accordingly, the touch detection part 700 may perform an operation in the touch sensing period TP.

When the generation of the output timing signal OTS is terminated and the touch end signal TED, which has a frequency greater than the frequency of the output timing signal OTS and a duty ratio different from the duty ratio of the touch start signal pulse TSTP, is received, the touch detection part 700 may change the touch synchronization signal i_tsyncn to the third level, and accordingly, the touch detection part 700 may perform the operation in the display period DP.

Finally, in the display apparatus according to an embodiment of the invention, as shown in FIG. 11, while the original touch synchronization signal TSYNC_T transmitted from the control part 400 is maintained at a first level, which is a high level, the touch control part 800 may transmit a high level signal corresponding to the first level to the touch detection part 700.

In addition, when the original touch synchronization signal TSYNC_T is changed from the first level to the second level, the touch control part 800 may transmit a touch control signal PWM_TX including a touch sensing period signal TST and an output timing signal OTS to the touch detection part 700.

In this case, a period during which a high-level signal corresponding to the first level is generated may correspond to the display period DP. Also, the high-level signal corresponding to the first level may be the touch control signal PWM_TX transmitted to the touch detection part 700 during the display period DP.

For example, when a high-level signal is transmitted to the touch detection part 700 during the display period DP, noise generated from the display apparatus may be reduced.

However, when a low-level signal is transmitted to the touch detection part 700 during the display period DP, noise generated from the display apparatus may be reduced.

Accordingly, according to the type and magnitude of noise generated during the display period DP, the touch control signal PWM_TX transmitted to the touch detection part 700 during the display period DP may have a low level as shown in FIGS. 5 and 8 - 10 and may have a high level as shown in FIG. 11.

The display apparatus according to the inventive concepts may be applied to all electronic devices requiring display of an image. For example, the display apparatus according to the inventive concepts may be applied to a virtual reality (VR) device, an augmented reality (AR) device, a mobile device, a video phone, a smart watch, a watch phone, or a wearable device, foldable device, rollable device, bendable device, flexible device, curved device, electronic notebook, e-book, PMP (portable multimedia player), PDA (personal digital assistant), MP3 player, mobile medical device, desktop PC, laptop PC, netbook computer, workstation, navigation, car navigation, vehicle display apparatuses, televisions, wall paper display apparatuses, signage devices, game devices, laptops, monitors, cameras, camcorders, and home appliances.

According to the display apparatus according to an embodiment of the invention, the number of signals transmitted between the touch control part and the touch detection part may be reduced, and the number of transmission lines provided between the touch control part and the touch detection part may be reduced.

Accordingly, miniaturization of the display apparatus may be possible, and manufacturing costs of the display apparatus may be reduced.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A display apparatus comprising:
a display panel;
a touch detection part configured to supply touch driving signals to touch electrodes provided in the display panel and detect touch on the display panel based on touch electrode signals received from the touch electrodes; and
a touch control part configured to transmit a touch control signal including a touch sensing period signal indicating a touch sensing period in which touch is sensed and an output timing signal related to an output timing of touch driving signals output during the touch sensing period to the touch detection part,
wherein the touch detection part is configured to generate signals to be used in the touch detection part by using the touch control signal.

2. The display apparatus of claim 1, wherein the touch detection part is configured to generate a touch synchronization signal for distinguishing the touch sensing period from a display period in which an image is displayed and a touch timing signal for controlling output of the touch driving signals by using the touch control signal.

3. The display apparatus of claim 1, wherein:
the touch control part generates the touch control signal by using an original touch synchronization signal transmitted from a control part and transmits the touch control signal to the touch detection part; and
the original touch synchronization signal is a signal that distinguishes the touch sensing period from a display period in which an image is displayed.

4. The display apparatus of claim 3, wherein:
when the original touch synchronization signal transmitted from the control part is changed from a first level to a second level, the touch control part generates a touch start signal indicating a timing at which the touch sensing period starts;
the touch control part generates the output timing signal when a preset period elapses after the touch start signal is generated; and
the touch control part is configured to generate a touch end signal indicating a timing at which the touch sensing period ends when a preset period elapses after the output timing signal is generated.

5. The display apparatus of claim 4, wherein a timing at which the touch end signal is terminated occurs earlier than or the same as a timing at which the original touch synchronization signal is changed from the second level to the first level.

6. The display apparatus of claim 1, wherein:
the touch sensing period signal includes:
a touch start signal indicating a timing of a start of the touch sensing period; and
a touch end signal indicating a timing of an end of the touch sensing period; and
the output timing signal is generated between the touch start signal and the touch end signal.

7. The display apparatus of claim 6, wherein a frequency and the number of touch start signal pulses constituting the touch start signal are the same as a frequency and number of touch end signal pulses constituting the touch end signal.

8. The display apparatus of claim 6, wherein a frequency of touch start signal pulses constituting the touch start signal is different from a frequency of touch end signal pulses constituting the touch end signal.

9. The display apparatus of claim 6, wherein the number of touch start signal pulses constituting the touch start signal is different from the number of touch end signal pulses constituting the touch end signal.

10. The display apparatus of claim 6, wherein a width of a touch start signal pulse constituting the touch start signal is different from a width of a touch end signal pulse constituting the touch end signal.

11. The display apparatus of claim 6, wherein:
the touch control part transmits a high-level signal to the touch detection part while an original touch synchronization signal transmitted from a control part is maintained at a first level, which is the high level; and
the touch control part transmits the touch control signal including the touch sensing period signal and the output timing signal to the touch detection part when the original touch synchronization signal is changed from the first level to a second level.

12. The display apparatus of claim 6, wherein:
the touch detection part is configured to generate a touch synchronization signal for distinguishing the touch sensing period and a display period, and a touch timing signal for controlling the output of the touch driving signals by using the touch control signal;
the touch synchronization signal is changed from a third level to a fourth level when the touch start signal is terminated, and is changed from the fourth level to the third level when the touch end signal is terminated;
the touch detection part generates the touch timing signal while the touch synchronization signal is maintained at the fourth level; and
the touch timing signal includes touch timing signal pulses corresponding to output timing signal pulses included in the output timing signal.

13. The display apparatus of claim 12, wherein the touch detection part is configured to output touch driving signal pulses corresponding to the touch timing signal pulses to the touch electrodes.

14. The display apparatus of claim 6, wherein a frequency of a touch start signal pulse constituting the touch start signal is greater than a frequency of an output timing signal pulse constituting the output timing signal.
